(19) United States
(12) Patent Application Publication
(10) Pub. No.: US 2026/0170501 A1
(43) Pub. Date: Jun. 18, 2026

(54) REAL-TIME CLASSIFICATION OF NETWORK AND USER TRAFFIC ACROSS AUTHENTICATION PLATFORMS

(71) Applicant: AT&T Intellectual Property I, L.P., Atlanta, GA (US)

(72) Inventor: Michael Driscoll, Norwalk, CT (US)

(21) Appl. No.: 18/979,569

(22) Filed: Dec. 12, 2024

(51) Int. Cl. G06Q 20/40

(52) U.S. Cl. CPC G06Q 20/4016; G06Q 20/4014

(57) ABSTRACT

A method includes extracting, from an authentication transaction, a plurality of features, calculating, from the authentication transaction, a plurality of metrics, generating, for each feature and metric, a risk score, to produce a plurality of risk scores each quantifying a likelihood that a corresponding feature or metric is associated with anomalous activity, aggregating the plurality of risk scores to generate an aggregate risk score for the authentication transaction, assigning, based on a combination of the plurality of risk scores, the features, the metrics, and the aggregate risk score, the authentication transaction to a first risk segment of a plurality of risk segments, each risk segment being associated with a relative risk level, calculating, based on the combination and first risk segment, a likelihood that the authentication transaction is non-anomalous, and labeling the authentication transaction with the likelihood and processing the authentication transaction according to a rule associated with the label.

The present disclosure relates generally to network security and relates more particularly to devices, non-transitory computer-readable media, and methods for real-time classification of network and user traffic across authentication platforms to improve network capacity, accelerate network authentications, and reduce malicious traffic in a communications network.

### BACKGROUND

A cyberattack is an attempt by an unauthorized individual or group of individuals to access a computer network or system, usually for the purpose of altering, stealing, destroying, or exposing information stored in the computer network or system. One particular class of cyberattacks includes authentication and authorization attacks, which attempt to gain access to resources that require credentials, such as a username and password, associated with an authorized individual.

For instance, in a credential stuffing attack, credentials obtained from a breach of one service may be used by an unauthorized individual to attempt access to another service. In a brute force attack, unauthorized individuals may attempt to guess the password associated with an authorized user. A victim of an authentication and authorization attack may lose a significant amount of time and money attempting to mitigate the damage done by the attack.

### SUMMARY

In one example, the present disclosure describes a device, computer-readable medium, and method for improving the identification and mitigation (reduction) of malicious traffic in a communications network through real-time classification of network and user traffic across authentication platforms. For instance, in one example, a method performed by a processing system including at least one processor includes extracting, from network traffic traversing a communications network, an authentication transaction associated with an authenticating entity, extracting, from the authentication transaction, a plurality of features, calculating, from the authentication transaction, a plurality of metrics, generating, for each feature of the plurality of features and each metric of the plurality of metrics, a risk score, so that a plurality of risk scores is produced, where each risk score of the plurality of risk scores quantifies a likelihood that a corresponding feature or metric is associated with an anomalous activity, aggregating the plurality of risk scores to generate an aggregate risk score for the authentication transaction, assigning, based on a combination of the plurality of risk scores, the plurality of features, the plurality of metrics, and the aggregate risk score, the authentication transaction to a first risk segment of a plurality of risk segments, wherein each risk segment of the plurality of risk segments is associated with a relative risk level, calculating, based on the combination and the first risk segment, a likelihood that the authentication transaction is non-anomalous, and labeling the authentication transaction according to the likelihood with a label and processing the authentication transaction according to a rule associated with the label.

In another example, a non-transitory computer-readable medium stores instructions which, when executed by a processor, cause the processor to perform operations. The operations include extracting, from network traffic traversing a communications network, an authentication transaction associated with an authenticating entity, extracting, from the authentication transaction, a plurality of features, calculating, from the authentication transaction, a plurality of metrics, generating, for each feature of the plurality of features and each metric of the plurality of metrics, a risk score, so that a plurality of risk scores is produced, where each risk score of the plurality of risk scores quantifies a likelihood that a corresponding feature or metric is associated with an anomalous activity, aggregating the plurality of risk scores to generate an aggregate risk score for the authentication transaction, assigning, based on a combination of the plurality of risk scores, the plurality of features, the plurality of metrics, and the aggregate risk score, the authentication transaction to a first risk segment of a plurality of risk segments, wherein each risk segment of the plurality of risk segments is associated with a relative risk level, calculating, based on the combination and the first risk segment, a likelihood that the authentication transaction is non-anomalous, and labeling the authentication transaction according to the likelihood with a label and processing the authentication transaction according to a rule associated with the label.

In another example, a device includes a processor and a computer-readable medium storing instructions which, when executed by the processor, cause the processor to perform operations. The operations include extracting, from network traffic traversing a communications network, an authentication transaction associated with an authenticating entity, extracting, from the authentication transaction, a plurality of features, calculating, from the authentication transaction, a plurality of metrics, generating, for each feature of the plurality of features and each metric of the plurality of metrics, a risk score, so that a plurality of risk scores is produced, where each risk score of the plurality of risk scores quantifies a likelihood that a corresponding feature or metric is associated with an anomalous activity, aggregating the plurality of risk scores to generate an aggregate risk score for the authentication transaction, assigning, based on a combination of the plurality of risk scores, the plurality of features, the plurality of metrics, and the aggregate risk score, the authentication transaction to a first risk segment of a plurality of risk segments, wherein each risk segment of the plurality of risk segments is associated with a relative risk level, calculating, based on the combination and the first risk segment, a likelihood that the authentication transaction is non-anomalous, and labeling the authentication transaction according to the likelihood with a label and processing the authentication transaction according to a rule associated with the label.

### BRIEF DESCRIPTION OF THE DRAWINGS

The teachings of the present disclosure can be readily understood by considering the following detailed description in conjunction with the accompanying drawings, in which:

FIG. 1 illustrates an example network, or system, in which examples of the present disclosure may operate;

FIG. 2 illustrates a flowchart of an example method for classifying network traffic patterns in real time, in accordance with the present disclosure; and

FIG. 3 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure improves the identification and mitigation (reduction) of malicious traffic in a communications network through real-time classification of network and user traffic across authentication platforms. As discussed above, a cyberattack is an attempt by an unauthorized individual or group of individuals to access a computer network or system, usually for the purpose of altering, stealing, destroying, or exposing information stored in the computer network or system. One particular class of cyberattacks includes authentication and authorization attacks, which attempt to gain access to resources that require credentials, such as a username and password, associated with an authorized individual.

For instance, in a credential stuffing attack, credentials obtained from a breach of one service may be used by an unauthorized individual to attempt access to another service. In a brute force attack, an unauthorized individuals may attempt to guess the password associated with an authorized user. A victim of an authentication and authorization attack may lose a significant amount of time and money attempting to mitigate the damage done by the attack.

The nature of cyberattacks is constantly evolving. As businesses move more applications and information technology (IT) assets onto Internet-facing networks, attackers have shifted their strategies and developed attacks that no longer rely purely on brute force to breach a system or take critical infrastructure offline. There are many types of cyberattacks that represent increasingly diverse attack vectors, which makes detection and mitigation more difficult. These types of cyberattacks may include distributed denial of service (DDoS) attacks, malware, Web application attacks, application programming interface (API) attacks, domain name system (DNS) attacks, account takeovers, botnets, phishing and spear phishing campaigns, and advanced persistent threats (APTs), as well as the aforementioned authentication and authorization attacks.

DDoS attacks are malicious campaigns designed to shut down a website or make network resources unavailable to legitimate traffic and users. Attackers accomplish DDoS attacks by flooding websites or servers with so much malicious traffic that the websites or servers crash or are otherwise unable to operate.

Malware is malicious software that, once downloaded to devices or computer systems, can propagate malicious code (such as spyware) and spread through a network on its own to serve a variety of malicious purposes.

Web application attacks include vectors such as cross-site scripting (XSS), zero-day attacks, structured query language (SQL) injection, and other attacks that seek to take advantage of misconfigurations, design flaws, improper coding, and other vulnerabilities in applications.

API attacks use broken access controls, unencrypted communications, machine-in-the-middle attacks, and other methods to illegitimately access information systems and networks via APIs.

DNS attacks target the availability or stability of the DNS for a network.

Account takeovers are cyberattacks in which hackers take ownership of online accounts using stolen credentials.

Botnets are networks of infected devices that are controlled by a central threat actor or group. Botnets are often part of DDoS attacks.

Phishing and spear-phishing campaigns use deception and social engineering to trick victims into disclosing information that an attacker can use to steal personal data, money, and/or credentials.

APTs are stealthy cyberattacks that allow malicious actors to gain access to networks and remain active for extended periods of time, gathering and extracting valuable data.

Increasingly, attackers are combining attack methods to launch ever more sophisticated (and successful) cyberattacks. These attacks are not typically detected by current network security tools which rely on static rules and analysis. Examples of the present disclosure, by contrast, provide a dynamic process which scores and classifies network traffic into risk sectors to which rules may be applied to mitigate a cyberattack or accelerate normal (non-malicious) cyber activity.

An authentication and authorization attack may be prevented by monitoring for cybersecurity threats that may be signs of an attempted authentication and authorization attack. Some cybersecurity threats may manifest in the forms of specific types of network traffic (e.g., types of data packets) or network traffic patterns (e.g., sources, destinations, traffic volumes, authentication patterns, application usage, etc.). For instance, a certain number of failed login or authentication attempts within a short period of time, particularly across a plurality of distinct usernames, may be a sign of an unauthorized party attempting to gain access to an account or system through credential stuffing.

Although network security systems have been developed to detect and classify cybersecurity threats so that authentication and authorization attacks can be prevented or limited, these systems typically rely on fixed rules and/or conventional machine learning algorithms, as discussed above, which lack the ability to re-learn from ongoing performance. For instance, some conventional systems tend to classify network traffic patterns as either “good” (i.e., likely not a threat) or “bad” (i.e., likely a threat) depending on the source of the traffic patterns (i.e., the entity that is attempting to authenticate itself). In such a system, traffic originating from a source that exhibits a high number or rate of authentication attempts over a fixed interval of time may be classified as “bad,” whereas traffic originating from a more known non-malicious user may be classified as “good.” The types of network traffic patterns that are classified as “good” may be many times more numerous than the types of network traffic patterns that are classified as “bad.” As such, the system may attempt to specifically monitor for and detect the “bad” network traffic patterns, which are expected to be observed far less frequently than the “good” network traffic patterns. However, because strategies for cyberattacks are constantly changing and evolving, it may be difficult for such a system to correctly classify “bad” network traffic patterns associated with a new type of cyberattack whose signs are not yet fully known.

Examples of the present disclosure, by contrast, determine what types of network traffic patterns may be classified as “good” by using machine learning to characterize the patterns of “good” network traffic. The patterns of “good” network traffic can then be used to identify “bad” network traffic patterns based on dissimilarity (as quantified by distance, social networking, and/or other metrics) from the “good” network traffic patterns. A continuous feedback loop allows new data sources, signals, and updates to prior labels to be introduced, tested, and validated over time in order to continuously update the machine learning models and ensure that new or emerging cyberattack threats do not go undetected. Thus, in one example, new network traffic patterns that cannot be conclusively classified as “good” may be classified as “bad,” which increases the chances of correctly classifying as “bad” network traffic patterns associated with a new or previously unknown type of cyberattack.

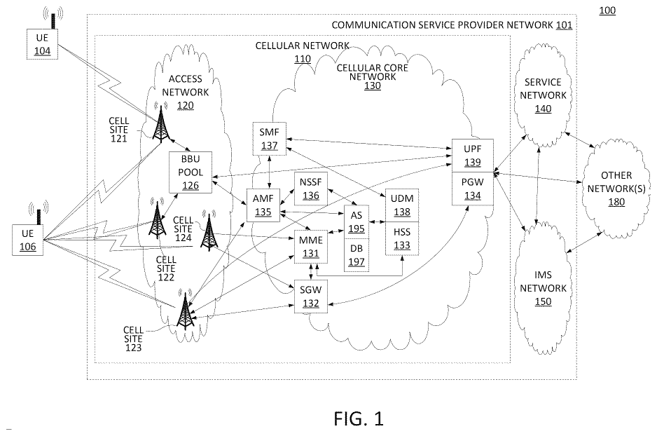

Although examples of the present disclosure are discussed within the context of authentication attacks, it will be appreciated that the approaches disclosed herein may also be effective at minimizing other types of cyberattacks. These and other aspects of the present disclosure are discussed in greater detail in connection with FIGS. 1-3, below.

FIG. 1 illustrates an example network, or system, 100 in which examples of the present disclosure may operate. In one example, the system 100 includes a communication service provider network 101. The communication service provider network 101 may comprise a cellular network 110 (e.g., a 5G network, a 4G/Long Term Evolution (LTE)/5G hybrid network, or the like), a service network 140, and an IP Multimedia Subsystem (IMS) network 150. The system 100 may further include other networks 180 connected to the communication service provider network 101.

In one example, the cellular network 110 comprises an access network 120 and a cellular core network 130. In one example, the access network 120 comprises a radio access network (RAN), such as a cloud RAN, a distributed RAN (D-RAN), a centralized RAN (C-RAN), a virtualized RAN (V-RAN), or an open RAN (O-RAN). For instance, a cloud RAN is part of the 3GPP 5G specifications for mobile networks. As part of the migration of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs) or radio units (RUs), may be deployed remotely from baseband units, e.g., atop cell site masts, buildings, and so forth. In one example, the BBU pool 126 may be located at distances as far as 20-80 kilometers or more away from the antennas/remote radio heads of cell sites 121 and 122 that are serviced by the BBU pool 126. It should also be noted in accordance with efforts to migrate to 5G networks, cell sites may be deployed with new antenna and radio infrastructures such as MIMO antennas, and millimeter wave antennas.

Although cloud RAN infrastructure may include distributed RRHs and centralized baseband units, a heterogeneous network may include cell sites where RRH and BBU components remain co-located at the cell site. For instance, cell site 123 may include RRH and BBU components. Thus, cell site 123 may comprise a self-contained “base station.” With regard to cell sites 121 and 122, the “base stations” may comprise RRHs at cell sites 121 and 122 coupled with respective baseband units of BBU pool 126. In one example, baseband unit functionality may be split into a centralized unit (CU) and a distributed unit (DU). In addition, the CU and the DU may be physically separate from one another. For instance, a DU may be situated with an RU/RRH at a cell site, while a CU may be in a centralized location hosting multiple CUs. Alternatively, or in addition, a single CU may serve multiple DUs and/or RUs/RRHs. In accordance with the present disclosure a “base station” may therefore comprise at least a BBU (e.g., in one example, a CU and/or a DU), and may further include at least one RRH/RU.

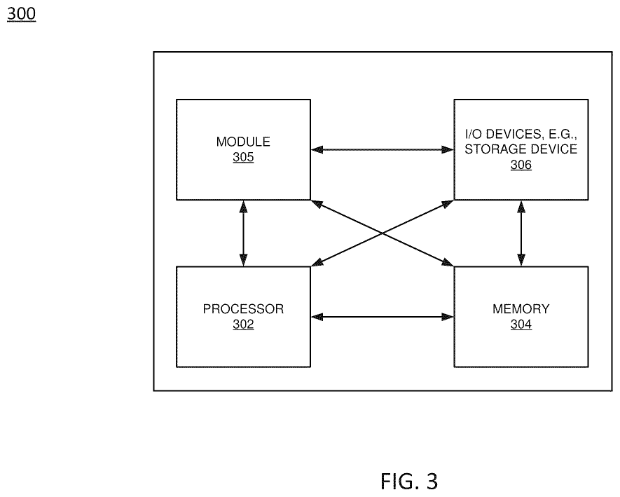

In accordance with the present disclosure, any one or more of cell sites 121-124 may be deployed with antenna and radio infrastructures, including MIMO and millimeter wave antennas. Furthermore, in accordance with the present disclosure, a base station (e.g., cell sites 121-124 and/or baseband units within BBU pool 126) may comprise all or a portion of a computing system, such as computing system 300 as depicted in FIG. 3, and may be configured to perform steps, functions, and/or operations in connection with examples of the present disclosure for classifying network traffic patterns in real time. However, it will be noted that a computing system configured to perform steps, functions, and/or operations in connection with examples of the present disclosure for classifying network traffic patterns in real time may be deployed at various other locations within the system 100 as well.

In one example, access network 120 may include both 4G/LTE and 5G/NR radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126.

In cellular core network 130, network nodes such as Mobility Management Entity (MME) 131 and Serving Gateway (SGW) 132 support various functions as part of the cellular network 110. For example, MME 131 is the control node for LTE access network components, e.g., eNodeB aspects of cell sites 121-123. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 5G network components, 3G network components, etc. Thus, cellular core network 130 may comprise an integrated network, e.g., including any two or more of 2G-5G infrastructures and technologies (or any future infrastructures and technologies to be deployed, e.g., 6G), and the like. For example, as illustrated in FIG. 1, cellular core network 130 further comprises 5G components, including: an access and mobility management function (AMF) 135, a network slice selection function (NSSF) 136, a session management function (SMF) 137, a unified data management function (UDM) 138, and a user plane function (UPF) 139.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, such as AMF(s), SMF(s), UPF(s), and so forth that may be arranged into different network slices which may logically be considered to be separate cellular networks. In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, and so forth.

In one example, SMF 137 may perform endpoint device IP address management, UPF selection, UPF configuration for endpoint device traffic routing to an external packet data network (PDN), charging data collection, quality of service (QoS) enforcement, and so forth. UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., a “5GC”). For instance, in non-standalone (NSA) mode architecture, LTE radio equipment may continue to be used for cell signaling and management communications, while user data may rely upon a 5G new radio (NR), including millimeter wave communications, for example. However, examples of the present disclosure may also relate to a hybrid, or integrated 4G/LTE-5G cellular core network such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and/or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1. It should be noted that intermediate devices and links between MME 131, SGW 132, cell sites 121-124, PGW 134, AMF 135, NSSF 136, SMF 137, UDM 138, and/or UPF 139, and other components of system 100 are also omitted for clarity, such as additional routers, switches, gateways, and the like.

FIG. 1 also illustrates various endpoint devices, e.g., user equipment (UE) 104 and 106. Each of the UEs 104 and 106 may comprise a cellular telephone, a smartphone, a tablet computing device, a laptop computer, a pair of computing glasses, a wireless enabled wristwatch, a wireless transceiver for a fixed wireless broadband (FWB) deployment, or any other cellular-capable mobile telephony and computing device (broadly, “an endpoint device”). For instance, each of the UEs 104 and 106 may include one or more radio frequency (RF) transceivers for cellular communications and/or for non-cellular wireless communications. In one example, each of the UEs 104 and 106 may be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive and/or to transmit multi-path and/or spatial diversity signals. UEs 104 and 106 may be utilized by users to provide information for authentication and access to systems of the cellular core network 130, the service network 140, the IMS network 150, and/or other networks 180.

In one example, each of the UEs 104 and 106 may comprise all or a portion of a computing system, such as computing system 300 depicted in FIG. 3, and may be configured to perform steps, functions, and/or operations in connection with examples of the present disclosure for classifying network traffic patterns in real time. In this regard, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

As illustrated in FIG. 1, UE 104 may access wireless services via the cell site 121 (e.g., NR alone, where cell site 121 comprises a gNB), while UE 106 may access wireless services via any of the cell sites 121-124 located in the access network 120 (e.g., for NR non-dual connectivity, for LTE non-dual connectivity, for NR-NR DC, for LTE-LTE DC, for EN-DC, and/or for NE-DC). For instance, in one example, UE 106 may establish and maintain connections to the cellular core network 130 via one or multiple gNBs (e.g., cell sites 121 and 122 and/or cell sites 121 and 122 in conjunction with BBU pool 126 and/or various other components, such as a CU and/or a DU). In another example, UE 106 may establish and maintain connections to the cellular core network 130 via a gNB (e.g., cell site 122 and/or cell site 122 in conjunction with BBU pool 126) and an eNodeB (e.g., cell site 124), respectively. In addition, either the gNB or the eNodeB may comprise a PCell, and the other may comprise a SCell for carrier aggregation and/or dual connectivity. Similarly, UE 106 may communicate with any of the cell sites 121 and 122 using carrier aggregation (CA) (e.g., in accordance with a CA technique). Furthermore, either or both of NR/5G and or EPC (4G/LTE) core network components may manage the communications between UE 106 and the cellular network 110 via cell site 122 and cell site 124.

In one example, the cellular core network 130 may further include an application server (AS) 195, which may comprise a computing system or server, such as computing system 300 depicted in FIG. 3, and may be configured to provide one or more operations or functions in connection with examples of the present disclosure for classifying network traffic patterns in real time. The cellular core network 130 may also include a database (DB) 197 that is communicatively coupled to the AS 195.

The AS 195 may comprise one or more physical devices, e.g., one or more computing systems or servers, such as computing system 300 depicted in FIG. 3, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

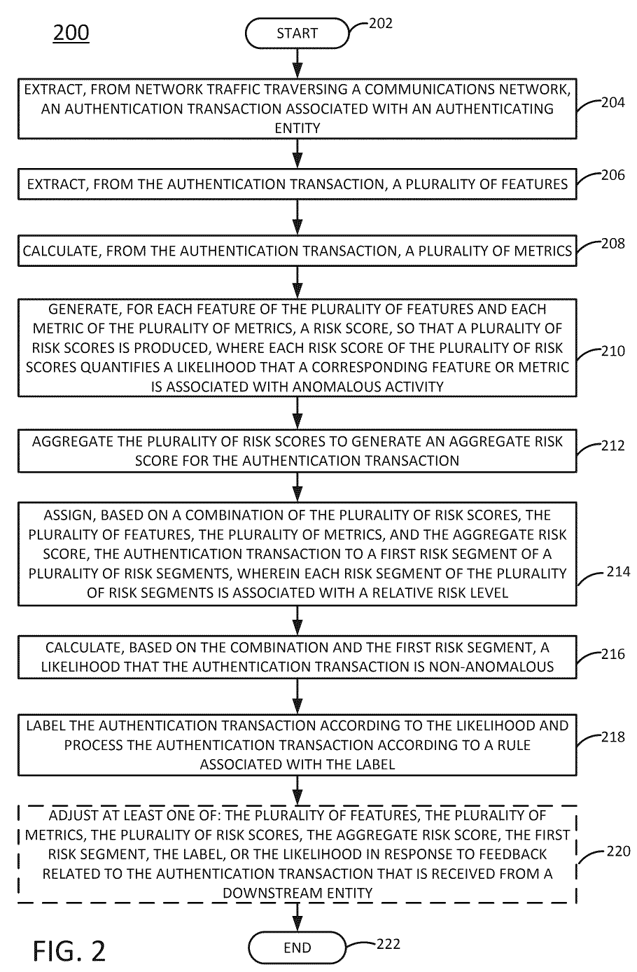

In one example, the AS 195 may be configured to classify network traffic patterns observed in the communication service provider network 101 in real time. For instance, in some examples, the AS 195 may be part of an identity access management (IAM) platform that controls user access to one or more services supported by the communication service provider network 101. For instance, the AS 195 may analyze samples of network traffic acquired during an attempted authentication process in order to determine whether the user who initiated the attempted authentication process is an authorized or unauthorized user. In one example, the IAM platform may include the classification and identification of anomalous activity impacting privilege access management and broadly zero-trust principals. As described in further detail below in connection with FIG. 2, the AS 195 may analyze features of the samples of network traffic in order to determine how dissimilar patterns in the samples of network traffic are from patterns associated with “normal” or non-malicious network traffic (e.g., patterns associated with authentication attempts initiated by authorized users).

In this example, the DB 197 may operate as a repository for scores or patterns associated with “normal” or baseline network traffic patterns (where the scores or patterns may be computed by the AS 195 or by another source). These scores or patterns may be continuously updated as the AS 195 (or another source) gains access to new sources of network traffic data and/or gains greater insight into which features of network traffic are most helpful in defining “normal” network traffic patterns. For instance, when the AS 195 generates a score for a real-time sample of network traffic, the AS 195 may compare the score for the real-time sample of network traffic to a score associated with “normal” network traffic that is stored in the DB 197.

In further examples, the DB 197 may store rules associated with different classes of network traffic, where the rules define actions for the AS 195 to take when a sample of network traffic is classified into one of the classes. The rules may evolve over time.

In one example, the DB 197 may comprise a physical storage device integrated with the AS 195 (e.g., a database server or a file server), or attached or coupled to the AS 195, in accordance with the present disclosure. In one example, the AS 195 may load instructions into a memory, or one or more distributed memory units, and execute the instructions for classifying network traffic patterns in real time, as described herein. One example method for classifying network traffic patterns in real time is described in greater detail below in connection with FIG. 2.

In one example, the cellular core network 130 may include multiple instances of the AS 195 and DB 197 distributed throughout the cellular core network 130, where the multiple instances each store identical data for the purposes of redundancy.

The foregoing description of the system 100 is provided as an illustrative example only. In other words, the example of system 100 is merely illustrative of one network configuration that is suitable for implementing examples of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs). In one example, any one or more of the cell sites 121-124 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132. Thus, these and other modifications are all contemplated within the scope of the present disclosure.

Moreover, it will be noted that although examples of the present disclosure are discussed within the context of mobility and web deployments, the approach disclosed herein may also support identification and authentication for digital subscriber line (DSL), broadband, and other access technology.

To further aid in understanding the present disclosure, FIG. 2 illustrates a flowchart of an example method 200 for classifying network traffic patterns in real time, in accordance with the present disclosure. In one example, the method 200 may be performed by an application server that is configured to classify network traffic traversing a communications network, such as the AS 195 illustrated in FIG. 1. However, in other examples, the method 200 may be performed by another device, such as the processor 302 of the system 300 illustrated in FIG. 3. For the sake of example, the method 200 is described as being performed by a processing system.

The method 200 begins in step 202. In step 204, the processing system may extract, from network traffic traversing a communications network, an authentication transaction associated with an authenticating entity. In one example, an authentication transaction may comprise network traffic associated with an attempt by the authenticating entity to gain access to resources for which access may be restricted to authorized individuals. For instance, the authentication transaction may include data packets or flows having sources and/or destinations associated with an authentication platform, or may include data packets that contain payloads or data used by an authentication platform (e.g., usernames, passwords, email addresses, mobile phone numbers, etc.). In one example, the processing system may be part of the authentication platform (e.g., part of an IAM system). The authenticating entity may comprise an individual (e.g., a human user) or a machine (e.g., a computer).

In one example, the communications network may be a communication service provider network. However, in other examples, the communications network may be any type of network used to manage the flow of communications to/from an entity, including a home network, an enterprise network, and the like.

In step 206, the processing system may extract, from the authentication transaction, a plurality of features.

In one example, the plurality of features may be obtained from across a plurality of different dimensions, such as: volumetric (e.g., counts of authorization attempts characterized by outcome), user behavioral (e.g., behavioral patterns reflected in the authentication transaction), geolocation (e.g., locations of endpoints of the authentication transaction), time and frequency (e.g., time of day, frequency or authorization attempts, day of week, etc.), performance of authentication (e.g., successes, failures, error or event codes, sequences of authentication, etc.), user access (e.g., type of device, operating system, or the like by the authenticating entity), user account (e.g., services, type of account, etc.), authentication methods, and/or unstructured threat or media data.

In one example, the plurality of features may be obtained from traffic logs acquired from a plurality of different data sources. For instance, the plurality of features may include user session data associated with the authentication transaction, customer account and fraud data associated with the authentication transaction, mobility and botnet data associated with the authentication transaction, threat and market intelligence data associated with the authentication transaction, a country associated with the authentication transaction, an application associated with the authentication transaction, a user identifier associated with the authenticating entity, user account data of the authenticating entity, an authorization sequence associated with the authentication transaction, an error code associated with the authentication transaction, data extracted from private (e.g., user/authenticating entity) and public (e.g., Internet) data sources, and/or partner data from other participants in the communications network. In a further example, the plurality of features may include attributes of the authentication transaction, such as one or more of: source IP address, destination IP address, flow identifier, size of packet payload, contents of packet payload (e.g., file type), or the like. In a further example, the plurality of features may be enriched with metadata to aid in classification, such as network source data, geolocation data, and/or threat data.

Over time, new information about the plurality of features may be acquired from new data sources that may not have previously been available. Acquiring the plurality of features from multiple different data sources, and allowing for new data sources to be integrated, allows for a “truth set” (e.g., a set of “good” or allowable data) to be built on an ongoing basis and to evolve with legitimate changes in network traffic patterns.

In one example, the features to be extracted may be predefined, for example through features engineering. The features to be extracted may evolve over time as the processing system gains access to new sources of data or learns which features are most helpful in discriminating between non-malicious and malicious network traffic.

In step 208, the processing system may calculate, from the authentication transaction, a plurality of metrics.

In one example, the plurality of metrics comprise metadata derived from calculations. In one example, the plurality of metrics may be obtained from across a plurality of different dimensions, such as: volumetric (e.g., counts of authorization attempts characterized by outcome), user behavioral (e.g., behavioral patterns reflected in the authentication transaction), geolocation (e.g., locations of endpoints of the authentication transaction), time and frequency (e.g., time of day, frequency or authorization attempts, day of week, etc.), performance of authentication (e.g., successes, failures, error or event codes, sequences of authentication, etc.), user access (e.g., type of device, operating system, or the like by the authenticating entity), user account (e.g., location, volume or services, type of account, etc.), authentication methods, and/or unstructured threat or media data.

For instance, the plurality of metrics may include attributes of flows contained in the authorization transaction, such as one or more of: volume of packets in a flow, length of time spanned by a flow, length of time elapsed between arrival of adjacent packets in the same flow, total number of authentication attempts contained in a flow, number of failed authentication attempts contained in a flow, or the like. In a further example, the plurality of metrics may include encoded features (e.g., a day of the week encoded as a numeral), counts and distinct counts of maximum and minimum values, aggregations of values over windows of time, graph metrics (e.g., weighted features based on intra and inter relationships to adjust former metrics derived from risk segment assignments, as discussed in further detail below; for instance, risk segments associated with a higher level of risk may also be associated with higher ranges of certain values), and/or concentration metrics (e.g., metrics encoding categorical features based on volumes and levels of risky traffic observed over a period of recent history).

In one example, the metrics to be calculated may be predefined, for example through feature engineering. The metrics to be calculated may evolve over time as the processing system gains access to new sources of data or learns which features are most helpful in discriminating between non-malicious and malicious network traffic.

In step 210, the processing system may generate, for each feature of the plurality of features and each metric of the plurality of metrics, a risk score, so that a plurality of risk scores is produced, where each risk score of the plurality of risk scores quantifies a likelihood that a corresponding feature or metric is associated with anomalous activity.

In one example, the plurality of risk scores may be generated using statistical distributions, finite mixtures and/or other statistical techniques. The processing system may compare each feature of the plurality of features to a corresponding feature of historical network traffic (or to a baseline for the feature that is derived from the historical network traffic) that is known to be non-anomalous (e.g., not associated with or known to signify a cyberattack) in order to generate the risk score for the feature. For instance, in one example, the risk score is a Z-score (e.g., a number of standard deviations above or below a mean value for the feature). Thus, the risk score may quantify how different a value of the feature is from a value of the corresponding feature in the historical network traffic. Risk scores for the plurality of metrics may be computed in a similar manner.

In one example, the risk score may infer a trust relationship between the endpoints of the authentication transaction based on at least one of: the networks to which the endpoints are connected, the geolocations of the endpoints, the users associated with the endpoints, features of the devices comprising the endpoints, or features of applications executing on the devices comprising the endpoints.

In one example, the processing system may remove redundant features and redundant metrics from the plurality of features and the plurality of metrics, prior to generating the plurality of risk scores.

In one example, dimensionality reduction techniques, such as principal component analysis (PCA) or auto encoders, may be used to identify when multiple features of the plurality of features (or multiple metrics of the plurality of metrics) are similar enough that the multiple features (or metrics) can be reduced to a smaller set of features (or metrics) without significant loss of information. For instance, each feature of the plurality of features (or each metric of the plurality of metrics) may be ranked based on the variance of its respective score relative to principal directions (of corresponding historical or baseline features) for the each feature (or the each metric). In one example, features (or metrics) whose covariance fall within a threshold range of each other may be considered to be redundant.

Examples of duplicative (or highly correlated) features and metrics may include counts of authentication attempts over similar windows of time (e.g., five minutes and fifteen minutes); a change in country and a change in region; the domain and Internet service provider (ISP) of the authenticating entity; the device and operating system of the authenticating entity; and error codes from authentication and performance outcomes.

In one example, removing redundant features and metrics may allow the processing system to derive weights for the remaining features and metrics or correlations between two or more different features or two or more different metrics. This allows the processing system to identify which features of the plurality of features and which metrics of the plurality of metrics may be most important (i.e., most discriminative in terms of separating non-anomalous traffic from anomalous traffic). In one example, a machine learning technique, such as logistic regression, Boost with Least Absolute Shrinkage and Selection Operator (LASSO), or a neural network, may be used to determine which features of the plurality of features and which metrics of the plurality of metrics may be most important.

In step 212, the processing system may aggregate the plurality of risk scores to generate an aggregate risk score for the authentication transaction.

In one example, the aggregation may comprise a sum of the plurality of risk scores. In a further example, the sum may be a weighted sum. For instance, as discussed above, the use of PCA or auto encoders to remove redundant features of the plurality of features and redundant metrics of the plurality of metrics may help the processing system to infer which features and metrics are most (or, conversely, least) important in separating non-anomalous traffic from anomalous traffic (e.g., most important in defining a distance of the authentication transaction from the anomalous traffic). The respective risk scores for the plurality of features and plurality of metrics may then be weighted accordingly (e.g., respective risk scores for more important features and metrics may be multiplied by larger weights, while respective risk scores for less important features and metrics may be multiplied by smaller weights, or features and metrics may be weighted to account for correlations between features and correlations between metrics).

In step 214, the processing system may assign, based on a combination of the plurality of risk scores, the plurality of features, the plurality of metrics, and the aggregate risk score, the authentication transaction to a first risk segment of a plurality of risk segments, wherein each risk segment of the plurality of risk segments is associated with a relative risk level.

In one example, the number of the plurality of risk segments may be predefined. For instance, the plurality of risk segments may be predefined to represent different types of traffic (e.g., anomalous, customer, other) or different types of threat levels (e.g., not anomalous, possibly anomalous, anomalous, undetermined). In one example, a clustering technique such as hierarchical clustering or k-modes clustering may be used to assign the authentication transaction to the first risk segment.

For instance, each risk segment of the plurality of risk segments may be associated with a respective threshold difference from a baseline score for non-anomalous network traffic. These respective threshold differences may help to classify authentication transactions using unsupervised learning. For instance, a difference that is less than a first threshold difference (e.g., 1) may be associated with a “non-anomalous” risk segment or class of network traffic; a difference that is greater than the first threshold difference but less than a second threshold difference (e.g., 2) may be associated with a “monitor further” risk segment or class of network traffic; a difference that is greater than the second threshold difference but less than a third threshold difference (e.g., 3) may be associated with a “alert generation” risk segment or class of network traffic; and a difference that is greater than the third threshold difference may be associated with an “anomalous” risk segment or class of network traffic. As discussed in further detail below, each risk segment may define one or more rules that control how the processing system treats authentication transactions that are assigned to the risk segment. Unsupervised learning techniques may bring similar authentication transactions together in a common risk segment and lead to graph metrics which can be used to guide calculation of metrics from future authentication transactions.

In one example, the threshold differences from the baseline score are configurable and may vary depending on the type of the communications network. For instance, for a communications network that routinely carries network traffic containing sensitive information (e.g., user identity, financial, or health information of individuals, financial or trade secret information of an enterprise, etc.), the threshold differences for “non-anomalous” or “monitor further” risk segments may be lower than the threshold difference for a communications network that typically carries network traffic containing less sensitive information (e.g., commercial streaming media).

In step 216, the processing system may calculate, based on the combination (of the plurality of risk scores, the plurality of features, the plurality of metrics, and the aggregate risk score), a likelihood that the authentication transaction is non-anomalous.

In one example, supervised learning techniques may be used to calculate the likelihood.

In step 218, the processing system may label the authentication transaction according to the likelihood and process the authentication transaction according to a rule associated with the label.

In one example, the likelihood calculated in step 216 may be associated with a label. The label may comprise one of a plurality of possible labels associated with different likelihoods or ranges of likelihoods. Moreover, each label may be associated with a rule that defines an action to perform with respect to the authentication transaction.

For instance, a label that indicates that an authentication transaction is “non-anomalous” may be associated with an action that routes data packets of authentication transactions to intended destinations, or logs an authenticating entity associated with an authentication transaction into a system that allows the authenticating entity to access restricted resources. In a further example, the action may additionally add an IP address associated with the authentication transaction or authenticating entity to a whitelist of allowed or “safe” IP addresses for the communications network.

In another example, a label that indicates that an authentication transaction is “monitor further” may be associated with an action that requests additional credentials from the authenticating entity. For instance, the action may include sending a code or hyperlink to a device, email address, or mobile phone number that is known to be associated with a user who the authenticating entity claims to be, where the authenticating entity is then expected to provide the code to the processing system or activate the hyperlink in order to cause a signal to be sent to the processing system. In another example, the action may include asking the authenticating entity to answer a security question to verify their identity.

In another example, a label that indicates that an authentication transaction is “alert generation” may be associated with an action that sends an alert to a human administrator to ask the human administrator to review the authentication transaction. The alert may include at least one of: the plurality of risk scores, the plurality of features, the plurality of metrics, the aggregate risk score, the first risk segment, or the label.

In another example, a label that indicates that an authentication transaction is “anomalous” may be associated with an action that discards data packets of the authentication transaction, quarantines the data packets of the authentication transaction, routes the data packets of the authentication transaction to a destination other than the intended destination of the data packets (e.g., a sandbox), or prevents the authenticating entity from gaining access to a system that provides access restricted resources. In a further example, the action may include adding an IP address associated with the authentication transaction or the authentication transaction to a blacklist of blocked IP addresses for the communications network.

In optional step 220 (illustrated in phantom), the processing system may adjust at least one of: the plurality of features, the plurality of metrics, the plurality of risk scores, the aggregate risk score, the first risk segment, the label, or the likelihood in response to feedback related to the authentication transaction that is received from a downstream entity.

For instance, a downstream entity, such as a system to which the authenticating entity was trying to authenticate, may provide feedback that either validates or negates the label applied to the authentication transaction. As an example, the authentication transaction may be labeled as “anomalous,” and data packets associated with the authentication transaction may be routed to a sandbox. The downstream entity may provide feedback to the processing system indicating that the downstream entity also believes the authentication transaction to be anomalous (e.g., the processing system labeled the authentication transaction correctly). Alternatively, the downstream entity may provide feedback to the processing system indicating that the downstream entity believes the authentication transaction to be non-anomalous or legitimate (e.g., the processing system labeled the authentication transaction correctly).

Thus, reinforcement learning may be used to tune one or more steps of the method 200 to improve the accuracy with which future authentication transactions are labeled and handled by the processing system.

The method 200 may end in step 222.

Although the method 200 describes the processing for a single authentication transaction, it will be appreciated that the steps 204-220 may be repeated for any number of authentication transactions traversing a communications network.

Although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

FIG. 3 depicts a high-level block diagram of a computing device specifically programmed to perform the functions described herein. For example, any one or more components or devices illustrated in FIG. 1 or described in connection with the method 200 may be implemented as the system 300. For instance, an application server (such as might be used to perform the method 200) could be implemented as illustrated in FIG. 3.

As depicted in FIG. 3, the system 300 comprises a hardware processor element 302, a memory 304, a module 305 for classifying network traffic patterns in real time, and various input/output (I/O) devices 306.

The hardware processor 302 may comprise, for example, a microprocessor, a central processing unit (CPU), or the like. The memory 304 may comprise, for example, random access memory (RAM), read only memory (ROM), a disk drive, an optical drive, a magnetic drive, and/or a Universal Serial Bus (USB) drive. The module 305 for classifying network traffic patterns in real time may include circuitry and/or logic for activating timers and tracking a number of attempts at reconnection to a communications network. The input/output devices 306 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for classifying network traffic patterns in real time (e.g., a software program comprising computer-executable instructions) can be loaded into memory 304 and executed by hardware processor element 302 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for classifying network traffic patterns in real time (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
extracting, by a processing system including at least one processor from network traffic traversing a communications network, an authentication transaction associated with an authenticating entity;
extracting, by the processing system from the authentication transaction, a plurality of features;
calculating, by the processing system from the authentication transaction, a plurality of metrics;
generating, by the processing system for each feature of the plurality of features and each metric of the plurality of metrics, a risk score, so that a plurality of risk scores is produced, where each risk score of the plurality of risk scores quantifies a likelihood that a corresponding feature or metric is associated with an anomalous activity;
aggregating, by the processing system, the plurality of risk scores to generate an aggregate risk score for the authentication transaction;
assigning, by the processing system based on a combination of the plurality of risk scores, the plurality of features, the plurality of metrics, and the aggregate risk score, the authentication transaction to a first risk segment of a plurality of risk segments, wherein each risk segment of the plurality of risk segments is associated with a relative risk level;
calculating, by the processing system based on the combination and the first risk segment, a likelihood that the authentication transaction is non-anomalous; and
labeling, by the processing system, the authentication transaction according to the likelihood with a label and processing the authentication transaction according to a rule associated with the label.

2. The method of claim 1, wherein the processing system is part of an identity access management platform.

3. The method of claim 2, wherein the identity access management platform includes privilege access management and zero-trust.

4. The method of claim 1, wherein the plurality of features includes at least one of: user session data, customer account and fraud data, mobility and botnet data, or threat and market intelligence data.

5. The method of claim 1, wherein the plurality of features is enriched with at least one of: network source data, geolocation data, or threat data.

6. The method of claim 1, wherein the plurality of features is obtained across at least one of the following dimensions: volumetric data, user behavioral data, geolocation data, unstructured threat data, or unstructured media data.

7. The method of claim 1, wherein the plurality of features includes at least one of: a source internet protocol address, a destination internet protocol address, a flow identifier, a size of a packet payload, or contents of a packet payload.

8. The method of claim 6, wherein the plurality of metrics includes at least one of: a volume of packets in a flow, a length of time spanned by a flow, a length of time elapsed between arrival of adjacent packets in a same flow, a total number of authentication attempts contained in a flow, or a number of failed authentication attempts contained in a flow.

9. The method of claim 1, wherein the aggregate risk score comprises a weighted sum of the plurality of risk scores, and each risk score of the plurality of risk scores is weighted in the weighted sum to indicate an importance of the each risk score in defining a distance of the authentication transaction from the anomalous activity.

10. The method of claim 1, wherein the first risk segment is associated with a relative risk level that is non-anomalous.

11. The method of claim 10, wherein an action for the relative risk level that is non-anomalous comprises at least one of: routing data packets of the authentication transaction to an intended destination, logging the authenticating entity into a system that requires authentication to access restricted resources, or adding an internet protocol address associated with the authentication transaction or the authenticating entity to a whitelist for the communications network.

12. The method of claim 1, wherein the first risk segment is associated with a relative risk level that is to be monitored further.

13. The method of claim 12, wherein an action for the relative risk level that is to be monitored further comprises at least one of: requesting additional credentials from the authenticating entity or asking the authenticating entity to answer a security question to verify an identity of the authenticating entity.

14. The method of claim 1, wherein the first risk segment is associated with a relative risk level for which an alert is to be generated.

15. The method of claim 14, wherein an action for the relative risk level for which the alert is to be generated comprises sending an alert to a human administrator to ask the human administrator to review the authentication transaction.

16. The method of claim 1, wherein the first risk segment is associated with a relative risk level of anomalous.

17. The method of claim 16, wherein an action for the relative risk level of anomalous comprises at least one of: discarding data packets of the authentication transaction, quarantining the data packets of the authentication transaction, routing the data packets of the authentication transaction to a destination other than an intended destination of the data packets, preventing the authenticating entity from gaining access to a system that requires authentication to access restricted resources, or adding an internet protocol address associated with the authentication transaction or the authenticating entity to a blacklist for the communications network.

18. The method of claim 1, further comprising:
adjusting, by the processing system, at least one of: the plurality of features, the plurality of metrics, the plurality of risk scores, the aggregate risk score, the first risk segment, the label, or the likelihood in response to feedback related to the authentication transaction that is received from a downstream entity.

19. A non-transitory computer-readable medium storing instructions which, when executed by a processing system including at least one processor, cause the processing system to perform operations, the operations comprising:
extracting, from network traffic traversing a communications network, an authentication transaction associated with an authenticating entity;
extracting, from the authentication transaction, a plurality of features;
calculating, from the authentication transaction, a plurality of metrics;
generating, for each feature of the plurality of features and each metric of the plurality of metrics, a risk score, so that a plurality of risk scores is produced, where each risk score of the plurality of risk scores quantifies a likelihood that a corresponding feature or metric is associated with an anomalous activity;
aggregating the plurality of risk scores to generate an aggregate risk score for the authentication transaction;
assigning, based on a combination of the plurality of risk scores, the plurality of features, the plurality of metrics, and the aggregate risk score, the authentication transaction to a first risk segment of a plurality of risk segments, wherein each risk segment of the plurality of risk segments is associated with a relative risk level;
calculating, based on the combination and the first risk segment, a likelihood that the authentication transaction is non-anomalous; and
labeling the authentication transaction according to the likelihood with a label and processing the authentication transaction according to a rule associated with the label.

20. A device comprising:
a processing system including at least one processor; and
a computer-readable medium storing instructions which, when executed by the processing system, cause the processing system to perform operations, the operations comprising:
extracting, from network traffic traversing a communications network, an authentication transaction associated with an authenticating entity;
extracting, from the authentication transaction, a plurality of features;
calculating, from the authentication transaction, a plurality of metrics;
generating, for each feature of the plurality of features and each metric of the plurality of metrics, a risk score, so that a plurality of risk scores is produced, where each risk score of the plurality of risk scores quantifies a likelihood that a corresponding feature or metric is associated with an anomalous activity;
aggregating the plurality of risk scores to generate an aggregate risk score for the authentication transaction;
assigning, based on a combination of the plurality of risk scores, the plurality of features, the plurality of metrics, and the aggregate risk score, the authentication transaction to a first risk segment of a plurality of risk segments, wherein each risk segment of the plurality of risk segments is associated with a relative risk level;
calculating, based on the combination and the first risk segment, a likelihood that the authentication transaction is non-anomalous; and
labeling the authentication transaction according to the likelihood with a label and processing the authentication transaction according to a rule associated with the label.
